(19) United States
(12) Patent Application Publication
(10) Pub. No.: US 2005/0028388 A1
(43) Pub. Date: Feb. 10, 2005

(54) Pizza cutter

(76) Inventor: Ming-Chien Liu, Taichung Hsien (TW)

Correspondence Address: VARNDELL & VARNDELL, PLLC, 106-A S. COLUMBUS ST., ALEXANDRIA, VA, 22314, US

(21) Appl. No.: 10/635,457

(22) Filed: Aug. 7, 2003

(51) Int. Cl. B26B 3/00

(52) U.S. Cl. 30/319

(57) ABSTRACT

A pizza cutter has a cover, a handle and a circular blade. The handle is pivotally attached to the cover, and the circular blade is rotatably mounted inside the cover. The circular blade can be covered between the handle and the cover for storage. When the circular blade is dull, the circular blade can be replaced without discarding the whole pizza cutter. Further, because the circular blade can be completely enclosed by the cover and the handle, the circular blade will not injure a person when the pizza cutter is stored.

### BACKGROUND OF THE INVENTION

1. Field of the Invention

The present invention relates to a pizza cutter, and more particularly to a safety pizza cutter with a foldable handle to prevent a person from being injured by the pizza cutter.

2. Description of Related Art

With reference to FIG. 6, a conventional pizza cutter (40) has a handle (41) and a circular blade (43). The handle (41) has a distal end (not numbered), a proximal end (not numbered), a finger guard (not numbered), an extension (not numbered) and a through hole (42). The through hole (42) is defined on the distal end of the handle (41), and the finger guard is securely mounted on the proximal end of the handle (41). The extension is attached securely to and extend longitudinally from the proximal end of the handle (41). The circular blade (43) is rotatably mounted on the extension.

When the conventional pizza cutter (40) is used, the circular blade (43) is pressed into a pizza and pushed forward or pulled backward to cut the pizza. Because the circular blade (43) is completely exposed, the circular blade (43) of the conventional pizza cutter (40) can easily injure a person especially when the pizza cutter (40) is being retrieved from storage. Furthermore, replacing a dull circular blade (43) on a conventional pizza cutter (40) is virtually impossible for an ordinary person, and the whole pizza cutter (40) must be discarded, which is wasteful.

To overcome the shortcomings of the conventional pizza cutter, the present invention provides a pizza cutter to mitigate or obviate the aforementioned problem.

### SUMMARY OF THE INVENTION

An objective of the present invention is to provide a pizza cutter that can be used and stored safely. The pizza cutter in accordance with the present invention has a cover, a handle and a circular blade. The handle is pivotally attached to the cover, and the circular blade is rotatably mounted inside the cover. When the pizza cutter is not being used, the circular blade is completely covered by the handle and the cover.

When the circular blade is dull, the circular blade can be replaced so the whole pizza cutter does not have to be discarded. Further, the circular blade will not injure a person when the pizza cutter is stored because the circular blade is completely enclosed by the cover and the handle.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pizza cutter in accordance with the present invention;

FIG. 2 is an explored perspective view of the pizza cutter in FIG. 1;

FIG. 3 is an operational top plan view of the pizza cutter in FIG. 1 being assembled;

FIG. 4 is a cross sectional side plan view of the pizza cutter in FIG. 1 when the handle is closed;

FIG. 5 is a cross sectional side plan view of the pizza cutter in FIG. 1 when the handle is open; and

FIG. 6 is a perspective view of a conventional pizza cutter in accordance with the prior art.

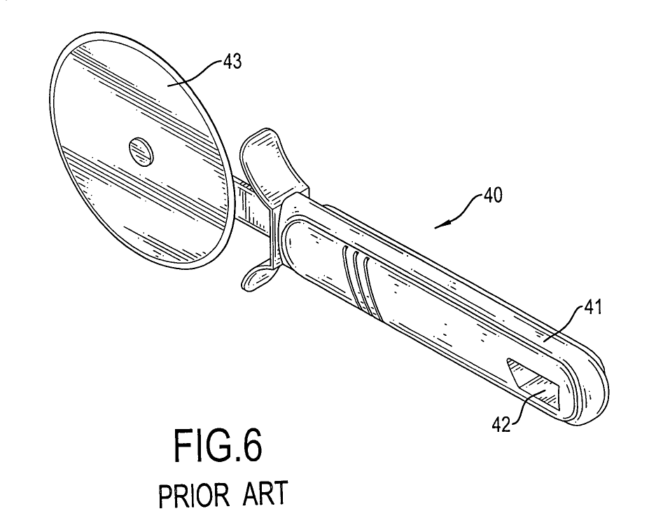

### DETAILED DESCRIPTION OF THE PREFERRED EMBODIMENT

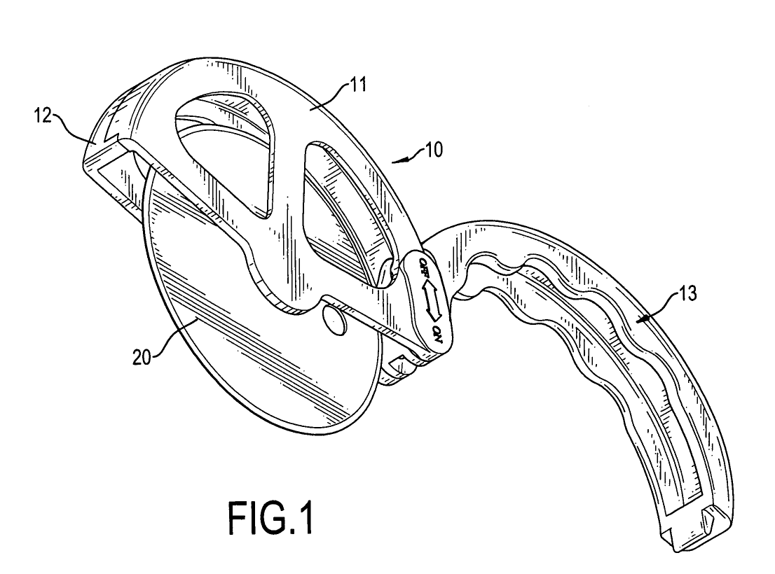

With reference to FIGS. 1, a pizza cutter in accordance with the present invention has a cover (10), a handle (13) and a circular blade (20).

The cover (10) is semicircular and has a proximal end (not numbered), a distal end (not numbered), a center (not numbered), a left side cover (11) and a right side cover (12). The left side cover (11) is securely attached to the right side cover (12), and the circular blade (20) is rotatably mounted between and protrudes from the left side cover (11) and the right side cover (12). The handle (13) is semicircular, has a distal end (not numbered) and a proximal end and is pivotally connected to the cover (10) to selectively cover the protruding circular blade (20) or serve as a grip to use the pizza cutter to cut a pizza.

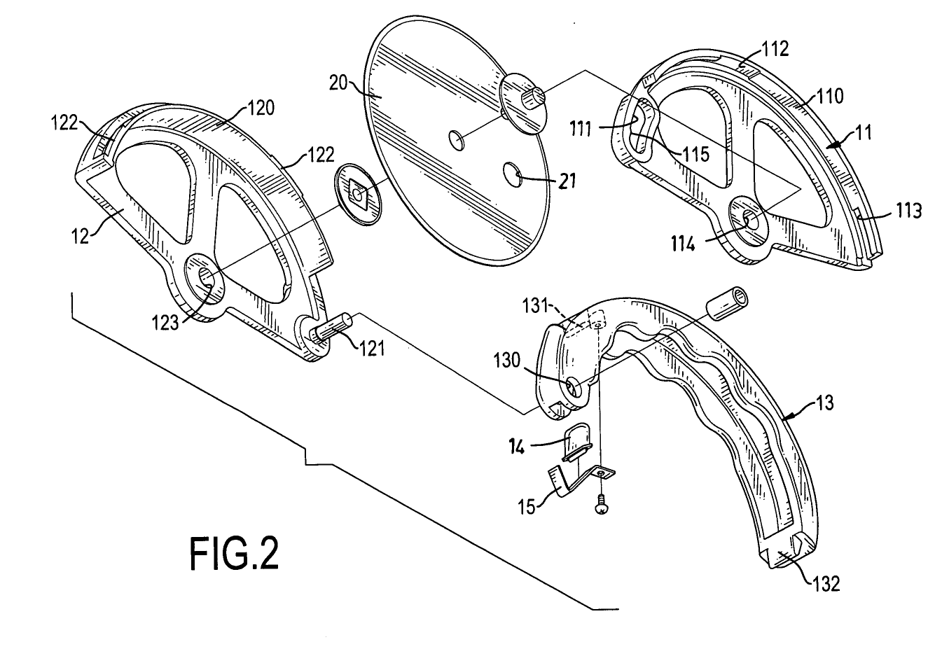

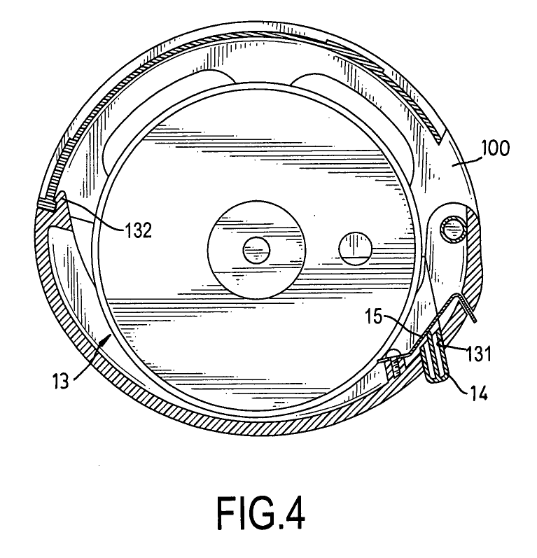

With further reference to FIGS. 2 and 4, the left side cover (11) in a specific embodiment of the pizza cutter is semi-circular and has an outer arcuate edge (not numbered), a center (not numbered), a bottom edge (not numbered), an outer arcuate lip (110), a distal end (not numbered), a proximal end (not numbered), an inside surface (not numbered), an arcuate recess (111) and a first central hole (114). The outer arcuate lip (110) has a proximal end (not numbered) and a distal end (not numbered) and is formed on the outer arcuate edge from the distal end toward the proximal end with a gap (not numbered) at the proximal end. The outer arcuate lip (110) has an inside surface (not numbered), a transverse keyway (112) and two narrow arcuate keyways (113). The transverse keyway (112) is defined on the inside surface of the outer arcuate lip (110). The narrow arcuate keyways (113) are respectively defined on the inside surface of the outer arcuate lip (110) at the inside surface of the left side cover (11) and one of the narrow arcuate keyways communicates with the transverse keyway (112). The arcuate recess (111) is defined at the proximal end of the left side cover (11) on the inside surface and has an inner sidewall (not numbered). A transverse ridge (115) is formed on the inner sidewall of the arcuate recess (111) near the proximal end of the left side cover (11). The center of the left side cover (11) is located at the bottom edge of the left side cover (11), and the first central hole (114) is defined at the center of the left side cover (11).

The right side cover (12) is attached to the left side cover (11) to form the semi-circular cover (10). The right side cover (12) is fundamentally the same shape as the left side cover ( 11) and has an outer arcuate edge (not numbered), a bottom edge (not numbered), a distal end (not numbered), a proximal end (not numbered), a center (not numbered), an inner arcuate lip (120), a shaft (121) and a second central hole (123). The center is located on the bottom edge of the right side cover (12).

The inner arcuate lip (120) is formed on the outer arcuate edge of the right side cover (12) from the distal end toward the proximal end with a gap (not numbered) at the proximal end. The inner arcuate lip (120) has an outside surface (not numbered), an inside surface (not numbered), a distal end (not numbered), a proximal end (not numbered), a transverse detent (not numbered) and at least two arcuate keys (122). The distal end of the arcuate lip (120) corresponds to the distal end of the right side cover (12). The arcuate keys (122) are formed on the outside surface of the inner arcuate lip (120) with one of the arcuate keys formed at the distal end of the inner arcuate lip (120). The gap at the proximal end of the inner arcuate lip (12) corresponds to and faces the gap at the proximal end of the outer arcuate lip (110). When the left side cover (11) is connected to the right side cover (12), the gaps form an opening (100) at the proximal end of the cover (10). The shaft (121) is securely attached to and protrudes from the inside surface of the right side cover (12) and has a distal end (not numbered).

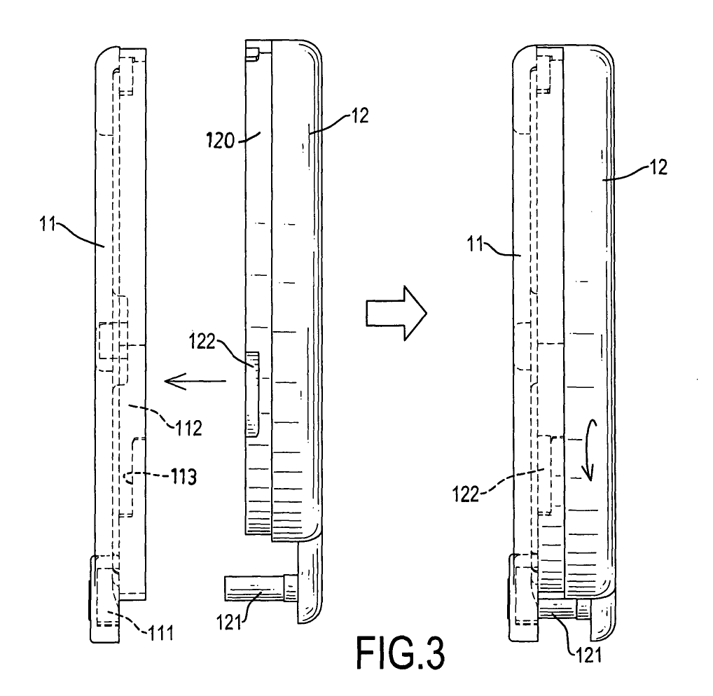

With further reference to FIG. 3, the left side cover (11) is attached to the right side cover (12) by inserting the arcuate keys (122) on the outer surface of the inner arcuate lip (120) into the narrow arcuate keyway (113) on the inside surface of the outer arcuate lip (110). The distal end of the shaft (121) is held inside the arcuate recess (111). The second central hole (123) defined at the center of the right side cover (12) and faces and is aligned with the first central hole (114) in the left side cover (11). Before assembling the right side cover (11) and the left side cover (12), one of the arcuate keys (122) is positioned inside the transverse keyway (112), the other arcuate key (122) is positioned at the distal end of the left side cover (11) and the distal end of the shaft (121) is positioned in the arcuate recess (111). Rotating one of the side covers causes the arcuate keys (122) to move into the narrow arcuate keyways (113) and the shaft (121) to move in the arcuate recess (111) until the distal end of the shaft (121) passes over and is held in place by the transverse ridge (115) in the arcuate recess (111).

With reference to FIGS. 2 and 4, the handle (13) pivotally connected to the cover (10) is semicircular and has an enlarged proximal end (not numbered), a distal end (not numbered), an outside surface (not numbered), an inner surface (not numbered), two inner edges (not numbered), a pivot hole (130), a wide slot (131), a narrow slot (not numbered), a tongue (132), a pushbutton (14) and a resilient stop (15). The inner edges of the handle (13) are wave-shaped and suitable for a person's fingers to grip the handle (13). The pivot hole (130) is defined through the enlarged proximal end. The narrow slot and the wide slot (131) are defined through the outside surface near the enlarged proximal end of the handle (13).

The tongue (132) is formed on and extends from the distal end of the handle (13) and has a distal end (not numbered) and a hook (not numbered). The hook is formed at the distal end of the tongue (132).

The resilient stop (15) is essentially V-shaped and has an attachment ear (not numbered), a distal end (not numbered) and a proximal end (not numbered). The attachment ear is formed on and protrudes from the proximal end and is securely attached to the inner surface of the handle (13) near the wide slot (131). The distal end extends through the narrow slot. The pushbutton (14) is mounted through the wide slot (131) and has a distal end (not numbered), a proximal end (not numbered) and an exterior lip (not numbered) formed around the proximal end of the pushbutton (14). The exterior lip keeps the pushbutton (14) from being pushed through the wide slot (131) by the resilient stop (15). The proximal end of the pushbutton (14) inside the handle (13) abuts the resilient stop (15).

The circular blade (20) rotatably mounted inside the cover is a flat disk has a center (not numbered), a central hole (not numbered), a through hole (21), a spindle (not numbered) and a spindle cover (not numbered) with an axis stub (not numbered). The through hole (21) is defined off center through the circular blade (20). The spindle is mounted through the central hole of the circular blade (20) and the spindle cover is mounted on the spindle extending out of the central hole. The spindle is mounted inside the first central hole (114) in the left side cover (11). The stub of the spindle cover is mounted inside the second central hole (123) in the right side cover (12).

With further reference to FIG. 4, the shaft (121) on the right side cover (12) is mounted through the pivot hole (130) to pivotally mount the handle (13) in the opening (100) in the cover (10) With the shaft (121) inside the arcuate recess (111). The pizza cutter is closed by pivoting the handle (13) until hook on the tongue (132) engages the transverse ridge on the distal end of the inner arcuate lip (120).

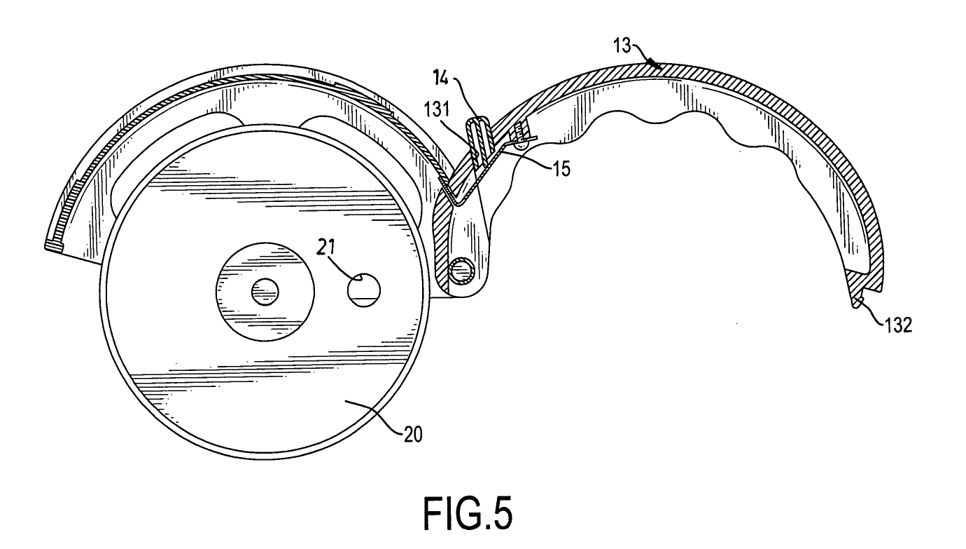

With reference to FIG. 5, the handle (13) is opened by pulling the distal end of the handle (13) out of the distal end of the cover, pressing the pushbutton (14) to retract the distal end of the resilient stop (15) into the handle (13), pivoting the handle (13) until it abuts the cover and releasing the pushbutton (14) so the distal end of the resilient stop (15) engages the proximal end of the inner arcuate lip (120). The free end of the resilient stop (15) engaging the proximal end of the inner arcuate lip (120) keeps the handle (13) from closing when the pizza cutter is being used.

The pizza cutter in accordance with the present invention has the following advantages.
1. When the circular blade (20) is dull, the circular blade (20) in the pizza cutter in accordance with the present invention can be replaced with a new circular blade (20) so the whole pizza cutter does not have to be thrown away.
2. The handle (13) on the pizza cutter in accordance with the present invention can be pivoted to completely enclose the circular blade (20) between the handle (13) and the cover (10) prevent a person from being injured.
3. The through hole (21) defined on the circular blade (20) provides a convenient way to store the pizza cutter by hanging the pizza cutter.
4. Because the handle (13) can be folded to abut the cover for storage, the pizza cutter is smaller than a conventional pizza cutter.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A pizza cutter comprising
a cover being semicircular and having
a right side cover, and
a left side cover attached to the right side cover;
a circular blade rotatably mounted between the right side cover and left side cover; and
a handle with an inner surface and a proximal end being selectively cover the circular blade and pivotally connected to the cover.

2. The pizza cutter as claimed in claim 1, wherein the left side cover further comprises
a distal end,
a proximal end,
a bottom edge,
an inside surface,
a center located on bottom edge,
an arcuate recess formed on the inside surface,
an outer arcuate lip formed form the distal end toward the proximal end with a gap at the proximal end and having
an inside surface,
a transverse keyway defined in the inside surface of the outer arcuate lip, and
at least two narrow arcuate keyways defined in the inside surface of the outer arcuate lip and one of the at least two narrow arcuate keyways communicating with the transverse keyway, and
a first central hole defined on the center, and
the right side cover comprises
a distal end,
a proximal end,
an outer arcuate edge,
a bottom edge,
a center located on the bottom edge,
an inner arcuate lip formed on the outer arcuate edge from the distal
end toward the proximal end with a gap and having
a distal end,
a proximal end,
an inside surface,
a transverse detent, and
at least two arcuate keys formed on the outside surface of the arcuate lip and respectively received in the at least two narrow arcuate keyways,
a shaft securely attached to the inside surface of the right side cover, extending through the proximal end of the handle and inserted into the arcuate recess, and
a second central hole defined in the center on the bottom edge, wherein the second central hole and the first central hole is used to hold the circular blade, and the right side cover and left side cove formed an opening at the proximal end to pivot with the handle.

3. The pizza cutter as claimed in claim 1, wherein the handle further comprises
a wide slot and a narrow slot respectively defined through the outside surface near the proximal end of the handle,
a pushbutton mounted through the wide slot and having
a distal end,
a proximal end, and
an exterior lip formed around the proximal end to keep the pushbutton inside the wide slot, and
a resilient stop attached to the inner surface of the handle and having
a distal end extended through the narrow slot,
a proximal end, and
an attachment ear formed on the proximal end and attached to the inner surface of the handle near the wide slot.

4. The pizza cutter as claimed in claim 1, wherein the handle further comprises a wave-liked inside edge.

5. The pizza cutter as claimed in claim 2, wherein a through hole is defined through the circular blade.

6. The pizza cutter as claimed in claim 1, wherein the handle has a distal end and a tongue extended formed on the distal end, and the cover has a distal end, the tongue is used to engage with the cover at the distal end.

7. The pizza cutter as claimed in claim 2, wherein the arcuate recess further comprises an inner sidewall and a transverse ridge formed on the inner sidewall.

8. The pizza cutter as claimed in claim 6, wherein the tongue of the handle further comprises a hook to engage the transverse ridge on the inner arcuate lip.
